(19) United States
(12) Patent Application Publication
(10) Pub. No.: US 2017/0059974 A1
(43) Pub. Date: Mar. 2, 2017

(54) LIGHT GUIDE DEVICE AND PROJECTOR

(71) Applicant: HON HAI PRECISION INDUSTRY CO., LTD., New Taipei (TW)

(72) Inventors: MING-CHIH SUN, New Taipei (TW); SHI-KAI HUANG, New Taipei (TW)

(21) Appl. No.: 15/013,652

(22) Filed: Feb. 2, 2016

(30) Foreign Application Priority Data
Aug. 31, 2015 (TW) 104128722

(51) Int. Cl. G03B 21/20; G03B 21/00; G03B 33/12; F21V 8/00

(52) U.S. Cl. CPC G03B 21/204; G02B 6/0096; G03B 21/008; G03B 33/12

(57) ABSTRACT

A projector includes a light source device, an optical mixing device, a light guide device, a prism group, a digital display, and projection lenses. The light guide device includes a hollow body; the body includes an inner surface and an exterior surface corresponding to the inner surface. The inner surface is coated with a first film, the exterior surface is coated with a second film, the first film is configured to partially reflect light rays, the second film is configured to totally reflect the light rays.

### FIELD

The subject matter herein generally relates to a projector.

### BACKGROUND

In general, a projector includes a light source, a light guide device, a prism group, a digital micro-mirror device, and projection lenses. The light guide device is used to concentrate light rays, increase a uniformity of light rays, and transmit the light rays to an object.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the disclosure. Implementations of the present technology will now be described, by way of example only, with reference to the attached figure.

FIG. 1 is a diagrammatic view of an embodiment of a projector with light-traces.

FIG. 2 is a diagrammatic view of the embodiment of a color wheel of the projector of FIG. 1.

FIG. 3 is a diagrammatic, cross sectional view of the embodiment of a light guide device of the projector of FIG. 1.

FIG. 4 is a diagrammatic, cross sectional view of the embodiment of the light guide device with light-traces of the projector of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to;” it specifically indicates open-ended inclusion or membership in the so-described combination, group, series and the like.

The present disclosure relates to a projector.

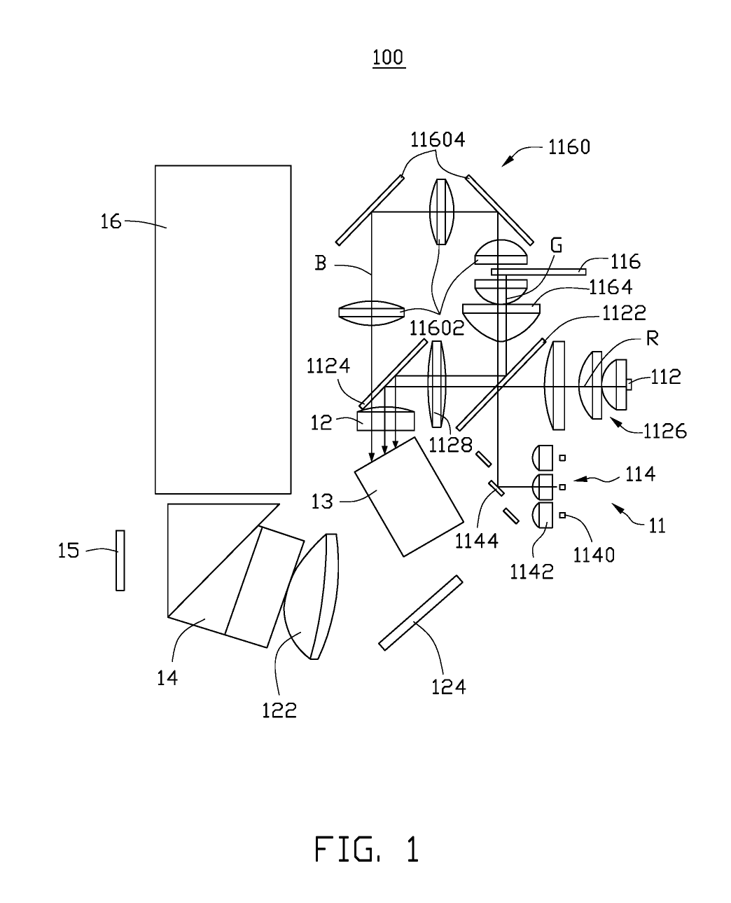

FIG. 1 illustrates a projector 100 with light traces (illustrated by arrows); the projector 100 includes a light source device 11, an optical mixing device 12, a light guide device 13, a reflector 124, a lens 122, a prism group 14, a digital display 15, and a projection lens group 16. The light source device 11 is configured to output red, blue, and green light with high luminance, the light source device 11 includes a light emitting diode 112, a laser emitting device 114, a color wheel 116, a lens group 1160, a first light splitter 1122, a second light splitter 1124, two focus lenses 1126, 1164, and a lens 1128.

The light emitting diode 112 emits a first visible light. In the illustrated embodiment, the first visible light is a red light R. The first light splitter 1122 and the second light splitter 1124 are opposite to each other and correspond to the light emitting diode 112. The first focus lenses 1126 are positioned between the light emitting diode 112 and the first light splitter 1122. The lens 1128 is positioned between the first light splitter 1122 and the second light splitter 1124. The first visible light is emitted from the light emitting diode 112 and is concentrated by the first focus lenses 1126, the first visible light passes through the first light splitter 1122, and the lens 1128 concentrates the first visible light to the second light splitter 1124, the second light splitter 1124 refracts the first visible light toward the optical mixing device 12. In the illustrated embodiment, the light splitters 1122, 1124 are dichroic mirrors and are configured to transmit or refract light to the optical mixing device 12.

The laser emitting device 114 emits a second visible light with high intensity. The laser emitting device 114 includes at least one laser generator 1140, at least one lens 1142, and at least one reflector 1144. In at least one embodiment, the second visible light is a blue light, B. The laser emitting device 114 includes three laser generators 1140, three lenses 1142, and three reflectors 1144. Each lens 1142 corresponds to the laser generator 1140 and is configured to concentrate the second visible light from the laser generator 1140, the reflector 1144 is configured to reflect the second visible light to the first light splitter 1122 from the lens 1142, the second visible light passes through the first light splitter 1122 and is positioned on the color wheel 116. In other embodiments, the laser emitting device 114 includes three laser generators 1140, a lens 1142, and a reflector 1144; the lens 1142 and the reflector 1144 correspond to the laser generators 1140.

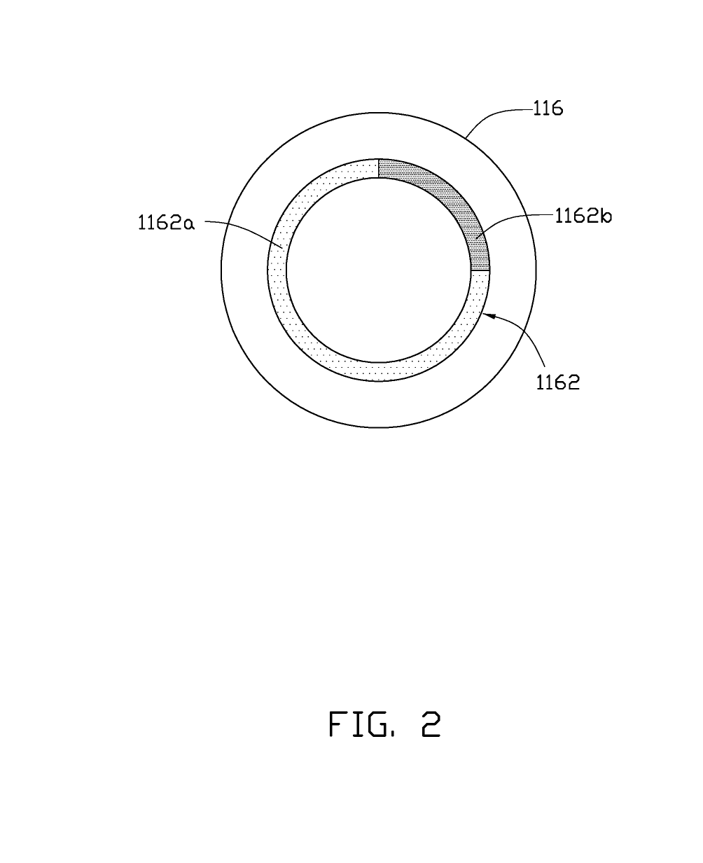

FIG. 2 illustrates the color wheel 116 is a plane and continues to rotate. The color wheel 116 includes a circular loop 1162. In at least one embodiment, the circular loop 1162 includes a first light irradiation area 1162a, and a second light irradiation area 1162b, the first light irradiation area 1162a includes a fluorescent layer, and the second light irradiation area 1162b is a transparent area.

The lens group 1160 includes three optical lenses 11602 and two mirrors 11604 opposite to each other, one mirror 11604 corresponds to the color wheel 116 and the other mirror 11604 corresponds to the second light splitter 1124, one optical lens 11602 is positioned between the mirrors 11604, another optical lens 11602 is positioned between one mirror 11604 and the color wheel 116, the other optical lens 11602 is positioned between the other mirror 11604 and the second light splitter 1124.

The second visible light passes the second light irradiation area 1162b into the lens group 1160, the optical lenses 11602 are configured to concentrate the second visible light to the mirrors 11604 and the second light splitter 1124, the mirrors 11604 are configured to reflect the second visible light to the optical lenses 11602, the second light splitter 1124 and the optical mixing device 12.

The fluorescent layer of the first light irradiation area 1162a is excited by the second visible light and emits a third visible light. In the illustrated embodiment, the third visible light is a green light, G. The second focus lenses 1164 are positioned between the color wheel 116 and the first light splitter 1122 and are configured to concentrate the third visible light to the first light splitter 1122. The third visible light is concentrated by the second focus lenses 1164 to the first light splitter 1122, the first light splitter 1122 refracts the third visible light toward the second light splitter 1124, the third visible light is concentrated to the second light splitter 1124 via the lens 1128 and is refracted to the optical mixing device 12 by the second light splitter 1124.

The optical mixing device 12 is configured to mix the visible lights to light rays and outputs the light rays to the light guide device 13.

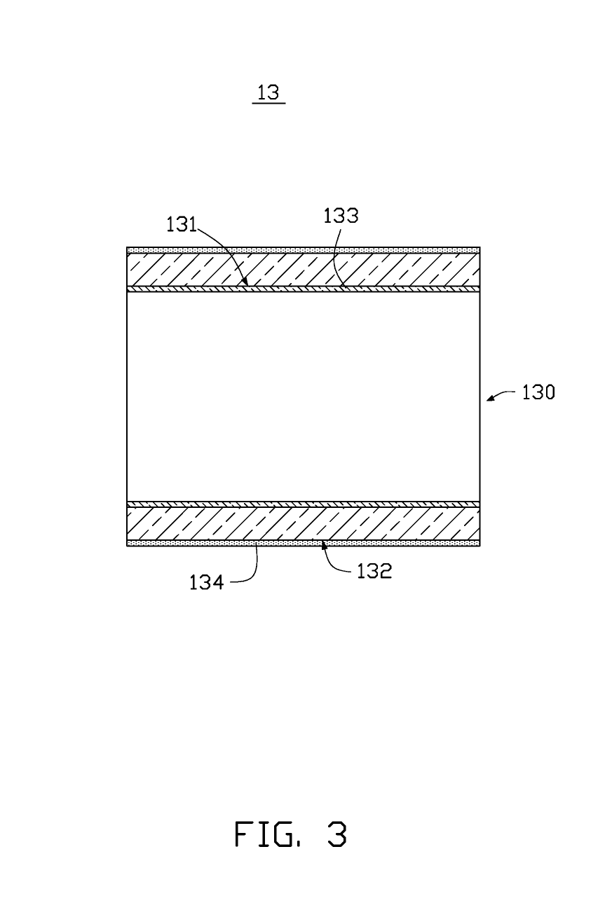

The illustrated embodiment of a cross section view of the light guide device 13 is shown in FIG. 3. The light guide device 13 includes a hollow body 130, a shape of a cross section of the light guide device 13 is selected from shapes including trapezoid, parallelogram, hexagon, square, rectangular, oval, and circular. In the illustrated embodiment, the shape of the cross section of the light guide device 13 is circular. The body 130 includes an inner surface 131 and an exterior surface 132 corresponding to the inner surface 131, the inner surface 131 is coated with a first film 133, the exterior surface 132 is coated with a second film 134, the first film 133 is configured to partially reflect the light rays, the second film 134 is configured to reflect the light rays with a total internal reflection. A material of the second film 134 is selected from gold, silver, copper, and aluminum. The first film 133 may be a half reflecting and half transparent film.

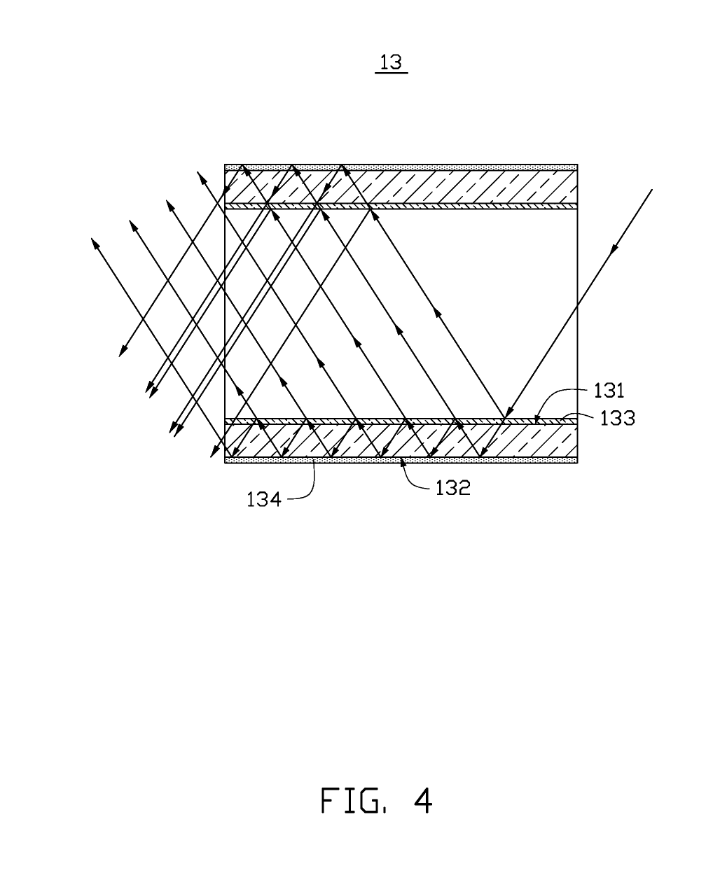

The illustrated embodiment of the cross section view of the light guide device 13 with light traces is shown in FIG. 4. The light rays are positioned on the inner surface 131 of the light guide device 13 from the optical mixing device 12, a portion of the light rays are reflected by the first film 133 and the other portion of the light rays pass the inner surface 131 to the exterior surface 132, the second film 134 reflects the other portion of the light rays toward the inner surface 131, and the other portion of the light rays are partially reflected by the first film 133. Therefore, the light ray is reflected by the first film 133 and the second film 134 multiple times for increasing a number of the refractions of the light rays and a number of the light rays, a uniformity of the light rays is increased by transmission in the light guide device 13. In at least one embodiment, the first film 133 is configured to reflect half of the light ray. The light ray is output from the light guide device 13 and is reflected to the lens 122 by the reflector 124; the lens 122 concentrates the light ray and inputs the light ray to the prism group 14.

The prism group 14 includes two prisms, in the illustrated embodiment, the prisms may be a combined reverse total internal reflection. The prism group 14 transmits the light ray toward the digital display 15; in the illustrated embodiment, the digital display 15 is a digital micro-mirror device. The digital display 15 receives the light rays and translates the light rays to optical image signals; the optical image signals are transmitted to the projection lens group 16 by the prism group 14 and are projected to a projection screen.

The embodiments shown and described above are only examples. Many details are often found in the art such as the other features of a projector. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A light guide device comprising:
a hollow body comprising:
an inner surface coated with a first film, and an exterior surface corresponding to the inner surface and coated with a second film,
wherein the first film is configured to partially reflect light rays, the second film is configured to reflect a majority of the light rays.

2. The light guide device in accordance with claim 1, wherein a sharp of a cross section of the light guide device is selected from sharps including trapezoid, parallelogram, hexagon, square, rectangular, oval, and circular.

3. The light guide device in accordance with claim 1, wherein a material of the second film is selected from gold, silver, copper, and aluminum.

4. A projector comprising:
a light source device including a light emitting diode, a laser emitting device, and a color wheel;
an optical mixing device;
a light guide device including a hollow body, the body comprising: an inner surface, and an exterior surface corresponding to the inner surface;
a prism group;
a digital display; and
projection lenses;
wherein the light emitting diode emits a first visible light, the laser emitting device emits a second visible light, the second visible light passes through the color wheel and the color wheel forms a third visible light, the first visible light, the second visible light, and the third visible light are mixed by the optical mixing device to output light rays;
wherein the inner surface is coated with a first film, the exterior surface is coated with a second film, the first film is configured to partially reflect the light rays, the second film is configured to totally reflect the light rays.

5. The projector in accordance with claim 4, wherein the first visible light is a red light, the light source device includes a first light splitter, a second light splitter, first focus lenses, and a first lens, the first light splitter and the second light splitter are opposite to each other and correspond to the light emitting diode, the first focus lenses are positioned between the light emitting diode and the first light splitter, the first lens is positioned between the first light splitter and the second light splitter, the first visible light passes through the first focus lenses and the first light splitter and is refracted to the optical mixing device by the second light splitter.

6. The projector in accordance with claim 5, wherein the color wheel is a plane with rotating and includes a first light irradiation area and a second light irradiation area, the first light irradiation area includes a fluorescent layer, the second light irradiation area is a transparent area, the first light irradiation area and the second light irradiation area are formed a circular loop on the color wheel.

7. The projector in accordance with claim 6, wherein the second visible light is a blue light, the laser emitting device includes a laser generator, a second lens, and a first reflector, the second visible light is emitted by laser generator and passes through the second lens and is reflected to the first light splitter by the first reflector, the second visible light passes through the first light splitter and is positioned on the color wheel.

8. The projector in accordance with claim 7, wherein the light source device includes a lens group comprising three optical lenses and two mirrors opposite to each other, one mirror corresponds to the color wheel, and the other mirror corresponds to the second light splitter, one optical lens is positioned between the mirrors, another optical lens is positioned between one mirror and the color wheel, the other optical lens is positioned between the other mirror and the second light splitter, the second visible light passes through the second light irradiation area and is reflected to the second light splitter and the optical mixing device by the lens group.

9. The projector in accordance with claim 7, wherein the fluorescent layer of the first light irradiation area of the color wheel is excited by the second visible light and emits the third visible light, the light source device includes a second focus lenses positioned between the color wheel and the first light splitter, the third visible light passes through the second focus lenses and is refracted to the optical mixing device by the first light splitter and the second light splitter.

10. The projector in accordance with claim 4, wherein a sharp of a cross section of the light guide device is selected from sharps including trapezoid, parallelogram, hexagon, square, rectangular, oval, and circular.
